(19) United States
(12) Patent Application Publication
(10) Pub. No.: US 2026/0230192 A1
(43) Pub. Date: Aug. 6, 2026

(54) COMMUNICATION APPARATUS, COMMUNICATION METHOD, AND PROGRAM

(71) Applicant: NTT, Inc., Tokyo (JP)

(72) Inventors: Hiroyuki FUKUMOTO, Tokyo (JP); Yosuke FUJINO, Tokyo (JP); Yuya ITO, Tokyo (JP); Seiji OMORI, Tokyo (JP); Yushi TABATA, Tokyo (JP); Ryota OKUMURA, Tokyo (JP); Takumi ISHIHARA, Tokyo (JP)

(21) Appl. No.: 19/153,112

(22) PCT Filed: Feb. 10, 2023
(86) PCT No.: PCT/JP2023/004606

§ 371 Date: Aug. 1, 2025

(51) Int. Cl. H04B 11/00; H04L 25/03

(52) U.S. Cl. CPC H04B 11/00; H04L 25/03019

(57) ABSTRACT

A communication apparatus for performing acoustic communication underwater includes a forward adaptive equalization circuit configured to perform waveform equalization on a data frame acquired by the acoustic communication in chronological order, a backward adaptive equalization circuit configured to perform waveform equalization on the data frame in reverse chronological order, and a selection synthesis circuit configured to sequentially select and output one of first data of a first equalizer output from the forward adaptive equalization circuit and second data of a second equalizer output from the backward adaptive equalization circuit, or to sequentially synthesize and output both of the first data and the second data.

### TECHNICAL FIELD

The present disclosure relates to a technique for receiving a sound wave underwater.

### BACKGROUND ART

In recent years, acoustic communication systems that transmit and receive sound waves underwater (including in the sea) have been constructed. FIG. 16 is an image diagram of a state in which acoustic communication is performed in the sea. As illustrated in FIG. 16, a communication device 100 is provided on a ship V, and a receiver array 9 connected with the communication device 100 is fixed in the sea. In this case, main factors that hinder the acoustic communication are a multipath wave and environmental noise. The multipath wave is generated by a delayed wave due to sea-surface reflection, sea-bottom reflection, structure reflection, or the like. For example, since the propagation speed of a sound wave propagating in the sea is approximately 1,500 m/s, a delay spread on the order of milliseconds occurs with a path difference of only a few meters. For similar reasons, Doppler spread is also larger than that of the radio wave. Since a spread factor defined by the product of the delay spread and the Doppler spread is larger than that in terrestrial wireless communication by an order of magnitude, and due to a short variation period of the fading, a system design sufficiently considering time-varying behavior is necessary. Therefore, an adaptive equalization unit such as a multi-channel decision feedback equalizer is widely used as a method of compensating for time-varying transmission path distortion (see Non-Patent Literature 1).

Moreover, when acoustic measurement underwater is performed in a coastal area, impulse noise is frequently observed. A main cause of occurrence of the impulse noise is presumed to be a marine organism M such as Alpheus. The Alpheus is widely and universally distributed in shallow sea areas shallower than 60 m in a temperate or tropical region from 40 degrees north latitude to 40 degrees south latitude (refer to Non-Patent Literature 2). In some cases, pulse sounds are observed 1,000 times or more per minute (refer to Non-Patent Literature 3), and in a case where a communication device is operated in a shallow sea area, it is necessary to sufficiently consider what impulsive noise gives to the communication quality.

### CITATION LIST

### Non-Patent Literature

Non-Patent Literature 1: M. Johnson, L. Freitag and M. Stojanovic, “Improved Doppler tracking and correction for underwater acoustic communications, “Proc. IEEE International Conference on Acoustics Speech, and Signal Processing, pp. 575-578, April 1997.
Non-Patent Literature 2: “Underwater noise caused by snapping shrimp,” University of California, division of war research at the U.S. Navy electronics laboratory, 1946.
Non-Patent Literature 3: WATANABE, “THE DISTRIBUTION OF SNAPPING SHRIMPS SOUNDS IN JAPANESE COASTAL AREAS FOR SEA ENVIRONMENTAL MONITORING,” J. JSCE, Ser. B2, Coastal engineering, vol. 73, no. 2, pp. I1393-I1398, October 2017.

### SUMMARY OF INVENTION

### Technical Problem

However, when impulse noise is superimposed on a data frame, erroneous feedback occurs in the adaptive equalization unit in the communication device at the time of occurrence of the impulse noise, and as a result, erroneous control is performed, so that the square error characteristic of the output of the adaptive equalization unit temporarily deteriorates. Such deterioration in the equalization characteristic starting from the impulse noise continues for a while after the occurrence of the impulse noise, and thus there is a problem that the performance of the adaptive equalization unit deteriorates in an underwater environment accompanied by impulse noise.

The present disclosure has been made in view of the above points, and an object of the present disclosure is to suppress performance deterioration of an adaptive equalization unit even in an underwater environment accompanied by impulse noise.

### Solution to Problem

In order to solve the above problem, an invention according to claim 1 is a communication device for performing acoustic communication underwater, the communication device including: a forward adaptive equalization unit that performs waveform equalization on a data frame acquired by the acoustic communication in a chronological order; a backward adaptive equalization unit that performs waveform equalization on the data frame in a reverse chronological order; and a selection synthesis unit that sequentially selects and outputs one of data of a first equalizer output outputted by the forward adaptive equalization unit and data of a second equalizer output outputted by the backward adaptive equalization unit, or sequentially synthesizes and outputs both of the data of the first equalizer output and the data of the second equalizer output.

### Advantageous Effects of Invention

As described above, the present invention provides an effect that it is possible to suppress performance deterioration of the adaptive equalization unit even in an underwater environment accompanied by impulse noise.

### BRIEF DESCRIPTION OF DRAWINGS

FIG. 1 is a configuration of a conventional communication device including a receiver array and an adaptive equalization unit of Non-Patent Literature 1.

FIG. 2 is a diagram illustrating a configuration of an adaptive equalization unit.

FIG. 3 is a conceptual diagram illustrating a problem of a conventional communication device.

FIG. 4 is a diagram illustrating a simulation model.

FIG. 5 is a diagram illustrating a snapshot of a simulation result.

FIG. 6 is a conceptual diagram illustrating a basic idea of the present embodiment.

FIG. 7 is a diagram illustrating a simulation model of the present embodiment.

FIG. 8 is a diagram illustrating a simulation result of the present embodiment.

FIG. 9 is a configuration diagram of a communication device according to a first embodiment.

FIG. 10 is a configuration diagram of a modification of the communication device according to the first embodiment.

FIG. 11 is a flowchart illustrating a communication method executed by the communication device according to the first embodiment.

FIG. 12 is a configuration diagram of a communication device according to a second embodiment.

FIG. 13 is a diagram illustrating QPSK mapping and a bit correspondence example.

FIG. 14 is a configuration diagram of a modification of the communication device according to the second embodiment.

FIG. 15 is a flowchart illustrating a communication method executed by the communication device according to the second embodiment.

FIG. 16 is an image diagram of a state in which acoustic communication is performed in the sea.

FIG. 17 is a hardware configuration diagram of a communication device as a computer.

### DESCRIPTION OF EMBODIMENTS

### Premise Technique

First, before describing embodiments of the present invention, a technique as a premise of the present embodiment will be described.

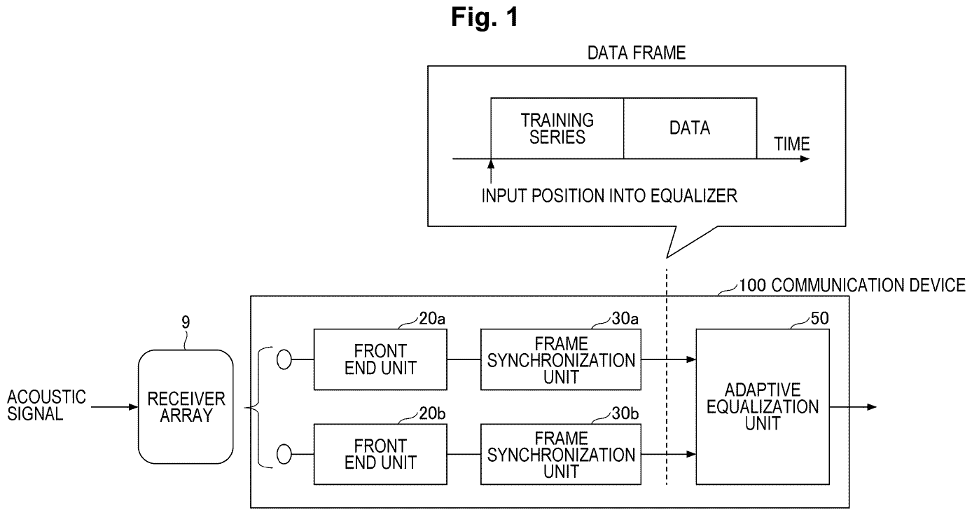

FIG. 1 is a configuration of a conventional communication device including a receiver array and an adaptive equalization unit of Patent Literature 1. A data frame to be transmitted includes a training series and a data portion. The training series is a signal series known on the reception side. The data portion is information itself, that is, an unknown signal series. However, the mapping pattern of the constellation of the data portion is known on the reception side. A communication device 100 assumes one-to-one transmission and reception.

As illustrated in FIG. 1, the conventional communication device 100 includes front end units 20a and 20b, frame synchronization units 30a and 30b, and an adaptive equalization unit 50. Note that, although the front end unit 20a and the frame synchronization unit 30a, and the front end unit 20b and the frame synchronization unit 30b are illustrated as a plurality of channels in FIG. 1, the number of channels may be three or more. Moreover, the generic name of the front end units 20a and 20b is referred to as a “front end unit 20”, and the generic name of the frame synchronization units 30a and 30b is referred to as a “frame synchronization unit 30”.

First, a receiver array 9 converts a sound wave underwater into an electric signal (acoustic signal). The front end unit 20 performs analog to digital (AD) conversion on the electric signal acquired from the receiver array 9, performs down-conversion processing, and performs signal conversion from a carrier band to a baseband. The frame synchronization unit 30 includes a frame detection means that detects the head position of the training series, and a Doppler shift estimation and correction unit that estimates and corrects the Doppler shift of the data frame. Signals received in each reception channel are sequentially inputted to the adaptive equalization unit from the head position of the training series. The adaptive equalization unit 50 performs waveform equalization processing on the basis of the inputted data and outputs data of an equalizer output (equalization result).

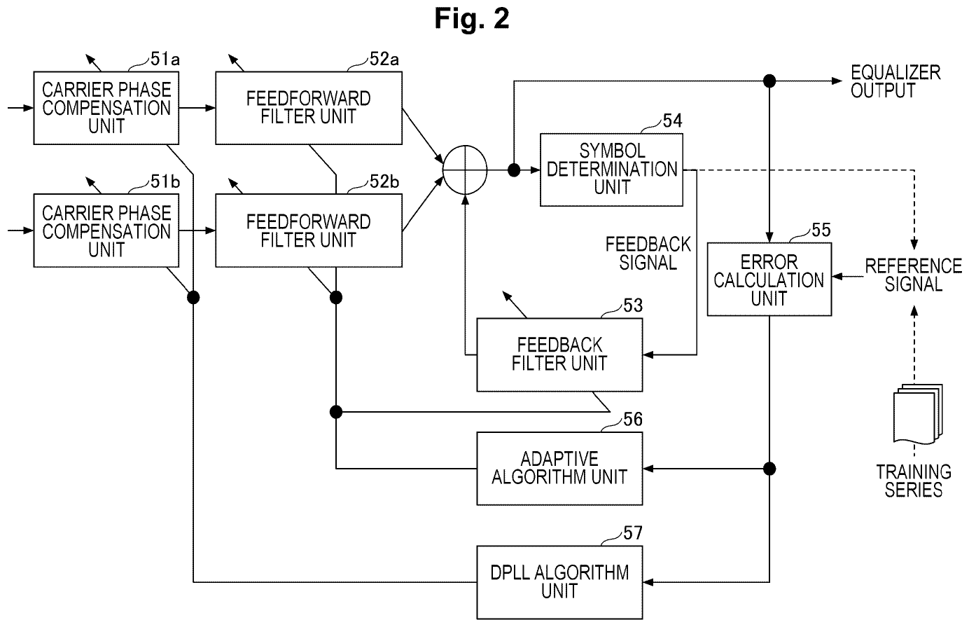

FIG. 2 illustrates a configuration of the adaptive equalization unit. The adaptive equalization unit 50 includes carrier phase compensation units 51a and 51b, feedforward filter units 52a and 52b, a feedback filter unit 53, a symbol determination unit 54, an error calculation unit 55, an adaptive algorithm unit 56, and a digital phase lock loop (DPLL) algorithm unit 57. Note that, although the carrier phase compensation unit 51a and the feedforward filter unit 52a, and the carrier phase compensation unit 51b and the feedforward filter unit 52b are illustrated as a plurality of channels in FIG. 2, the number of channels may be three or more. Moreover, the generic name of the carrier phase compensation units 51a and 51b is referred to as a “carrier phase compensation unit 51”, and the generic name of the feedforward filter units 52a and 52b is referred to as a “feedforward filter unit 52”.

The carrier phase compensation unit 51 compensates for a carrier phase by phase rotation with respect to the received signal. The feedforward filter unit 52 filters the received signal whose carrier phase has been compensated for by the carrier phase compensation unit 51, using a finite impulse response (FIR) filter. The feedback filter unit 53 filters the feedback signal using the FIR filter. The symbol determination unit 54 performs symbol determination of the output (equalizer output) of the adaptive equalization unit 50. The error calculation unit 55 calculates an error between the equalizer output and a reference signal. The adaptive algorithm unit 56 updates coefficients of the FIR filters included in the feedforward filter unit 52 and the feedback filter unit 53. The DPLL algorithm unit 57 calculates the phase correction amount of the carrier phase compensation unit.

With the above configuration, the adaptive equalization unit 50 uses a known training series illustrated in FIG. 1 as a reference signal, and operates the adaptive algorithm unit 56 on the basis of the square error between the equalizer output calculated by the error calculation unit 55 and the reference signal, in order to cause initial convergence of the feedforward filter unit 52 and the feedback filter unit 53. Then, the adaptive equalization unit 50 performs waveform equalization on the data portion illustrated in FIG. 1. The adaptive algorithm executed by the adaptive algorithm unit 56 includes a recursive least square (RLS) method and a least mean square (LMS) method. Since underwater communication has fast transmission path fluctuation, it is necessary to adjust a filter coefficient according to fluctuation of a transmission path response also in the data portion illustrated in FIG. 1. In order to realize this, a constellation symbol provisionally determined by the symbol determination unit 54 is used as a reference signal in the data portion. The constellation symbol indicates a predetermined candidate point among a plurality of candidate points (constellations) on a complex plane. In addition, the adaptive algorithm unit 56 sequentially updates each coefficient of the feedback filter unit 53 and the feedforward filter unit 52 on the basis of the square error between the equalizer output calculated by the error calculation unit 55 and the reference signal. The DPLL algorithm unit 57 obtains the fluctuation of the carrier wave phase in the data frame illustrated in FIG. 1, calculates the phase correction value, and feeds back the phase correction amount to the carrier phase compensation unit 51.

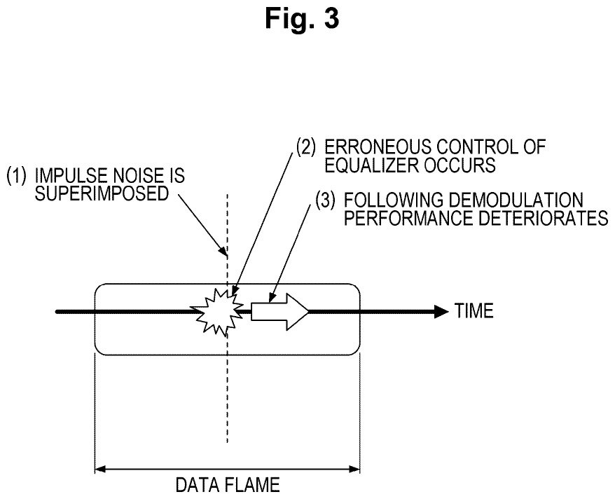

Next, FIG. 3 illustrates a problem of the conventional communication device 100. FIG. 3 is a conceptual diagram illustrating a problem of the conventional communication device. As an example, assume a situation in which the impulse noise is superimposed near the center of the data frame (1). At the point where the impulse noise occurs, the internal control of the adaptive equalization unit 50 is disturbed, and erroneous coefficient control is performed. Specifically, by the operation of the adaptive algorithm unit 56, erroneous information is fed back to the feedback filter unit 53 included in the adaptive equalization unit 50, in which each coefficient of the feedforward filter unit 52 and the feedback filter unit 53 is updated in a direction deviated from the optimum value (2). As a result, the demodulation performance deteriorates in the data section after the impulse noise is superimposed (3).

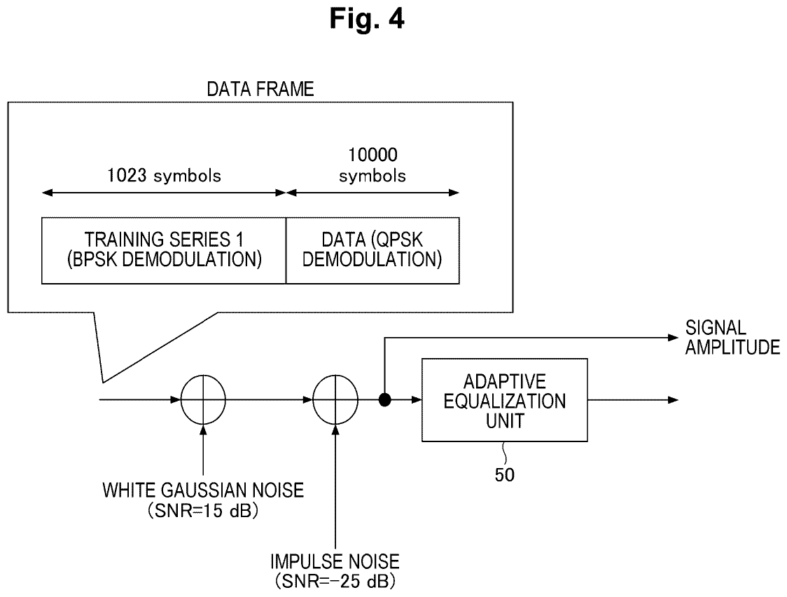

Here, a computer simulation is used to illustrate operation in an impulse noise environment. FIG. 4 is a diagram illustrating a simulation model. In the computer simulation, a transmission frame (training series of 1023 symbols, payload of 10000) is generated, and white Gaussian noise with a signal-to-noise ratio (SNR)=+15 dB is added. Then, an impulse noise of SNR=−25 dB is added to the 3000-th symbol. In order to simplify the simulation, the reception channel is set to 1 ch. The parameter setting of the adaptive equalization unit 50 is as shown in Table 1.

TABLE 1

| | |
|---|---|
| Parameter | Value |

| The number of reception channels | | 1 |
|---|---|---|
| The number of filter taps | Feedforward filter | 20 |
| | Feedback filter | 20 |

| | |
|---|---|
| Adaptive algorithm | RLS method |
| Forgetting coefficient | 0.999 |

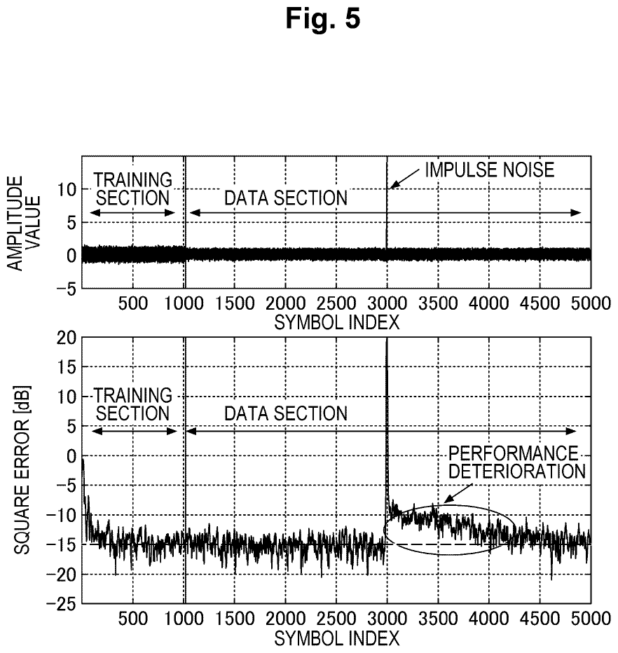

The transition of the square error between the equalizer output and the reference signal before and after mixing of the impulse noise is observed. FIG. 5 illustrates a snapshot of a simulation result. The upper diagram of FIG. 5 illustrates a received signal waveform on the in-phase side, and the lower diagram of FIG. 5 illustrates a square error. As illustrated in the lower diagram of FIG. 5, it can be seen that the square error increases once due to impulse noise in 3000 symbols. Then, although the square error gradually decreases, it can be seen that SNR is worse than SNR=+15 dB of white noise until 5000 symbols. As described above, the demodulation performance of the data after the superimposition of the impulse noise deteriorates.

Note that, since the frame length assumed in the acoustic communication ranges from several hundred msec to several seconds and various large and small impulse noises are superimposed even during 1 second, the performance of the adaptive equalization unit 50 deteriorates due to the influence of the impulse noise many times during one frame in practice.

Hereinafter, an embodiment of the present invention aims to suppress deterioration in demodulation performance after impulse noise.

### Description of Present Embodiment

### Background of Present Embodiment

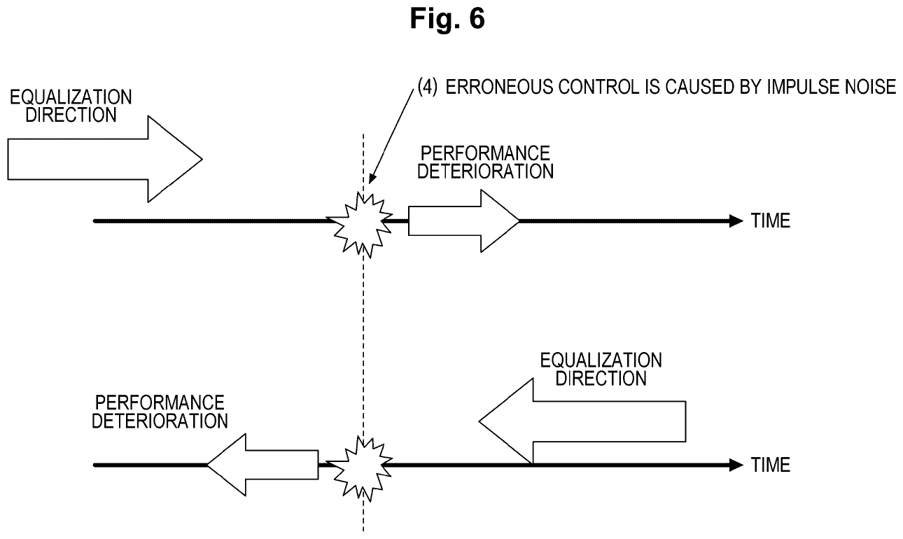

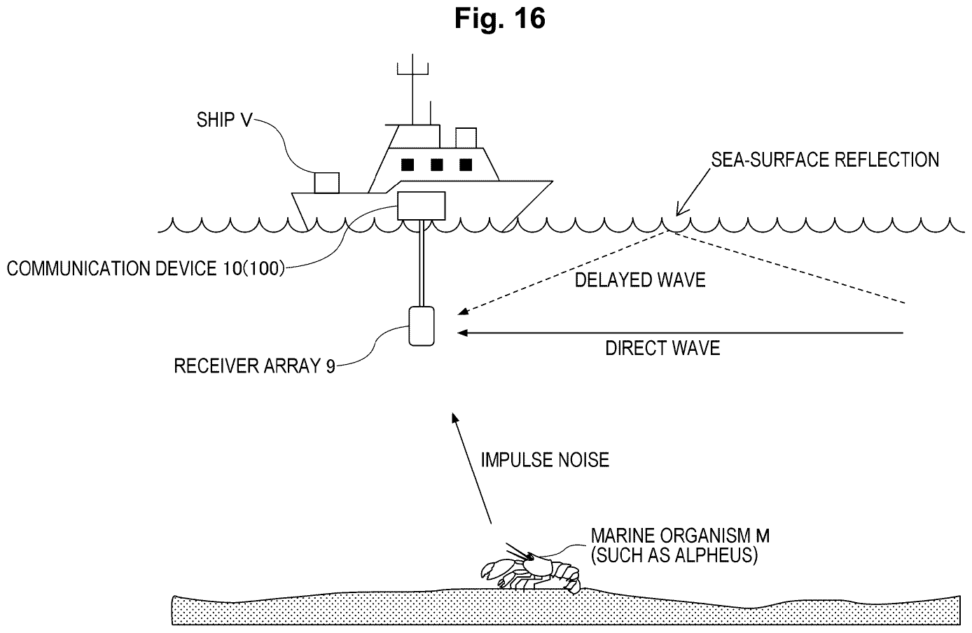

First, a basic idea of the present embodiment will be described with reference to FIG. 6. It is a conceptual diagram illustrating a basic idea of the present embodiment. Note that the communication device 10 according to the present embodiment is used similarly to the conventional communication device 100 as illustrated in FIG. 16.

In a case where waveform equalization is performed in a time-passing direction (forward direction) with respect to the time axis direction as in the conventional communication device 100, the performance of waveform equalization deteriorates after the occurrence of the impulse noise as described above (4). On the other hand, in a case where waveform equalization is performed in a direction (reverse direction) reverse to the direction of the time axis, the performance deterioration after the occurrence of the impulse noise is suppressed to be smaller than that in the waveform equalization in the forward direction, and the performance deterioration before the occurrence of the impulse noise increases. Therefore, it is considered that deterioration in performance after the occurrence of the impulse noise, which is a problem of the conventional communication device 100, is suppressed when the communication device 10 performs equalization from both directions and sequentially selects one of the equalizer outputs or sequentially synthesizes both of the equalizer outputs according to some norm. For example, a selection synthesis unit 60 to be described later of the communication device 10 performs equalization from both directions, first selects data of the first equalizer output in the forward direction, then selects data of the second equalizer output in the reverse direction, and then selects data of the first equalizer output in the forward direction according to some norm for both equalizer outputs. Alternatively, a selection synthesis unit 60 to be described later of the communication device 10 performs equalization from both directions, first synthesizes the data of the first equalizer output in the forward direction and the data of the second equalizer output in the reverse direction at a ratio of 1:2, and then synthesizes the data of the first equalizer output in the forward direction and the data of the second equalizer output in the reverse direction at a ratio of 2:1, according to some norm for both equalizer outputs.

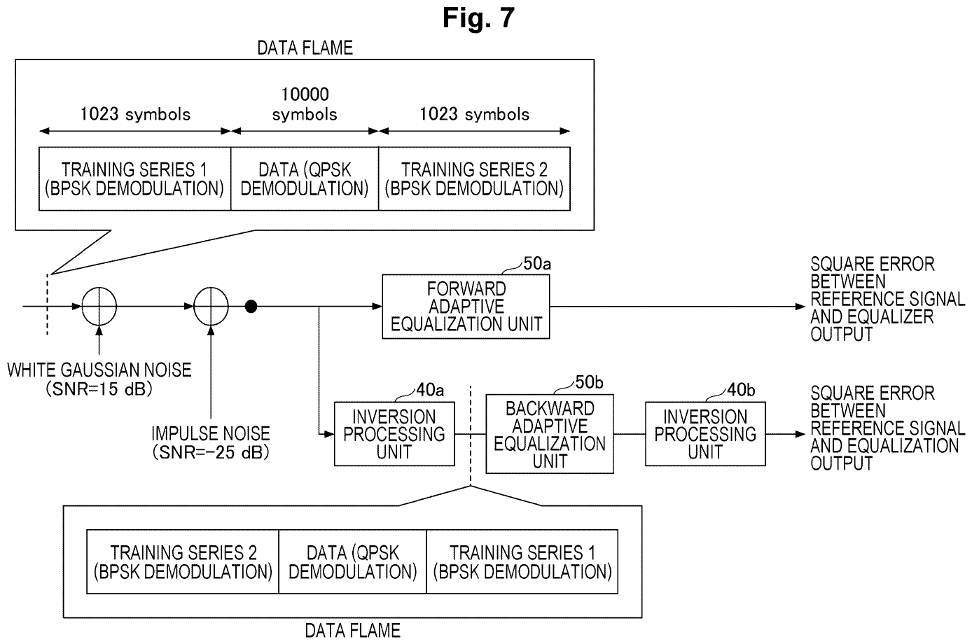

Next, the operation is checked using computer simulation. FIG. 7 is a diagram illustrating a simulation model of the present embodiment. In this simulation, a transmission frame (training series 1: 1023 symbols, payload of 10000 symbols, training series 2: 1023 symbols) is generated, and white Gaussian noise with a signal-to-noise ratio (SNR)=+15 dB is added. Then, an impulse noise of SNR=−25 dB is added to the 3000-th symbol. In order to simplify the simulation, the reception channel is set to 1 ch. The first adaptive equalization unit (forward adaptive equalization unit 50a) causes convergence of the filter coefficient using the training series 1 and then performs waveform equalization of the data section. The inversion processing unit 40a replaces the chronological order of a received data frame, and inputs data from the last symbol of the training series 2 at the rear end of the data frame to the second adaptive equalization unit (backward adaptive equalization unit 50b). The backward adaptive equalization unit 50b causes initial convergence of the filter coefficient using the training series 2, and then performs waveform equalization of the data section. Finally, the inversion processing unit 40b aligns the series order of the data by the inversion processing to obtain an output.

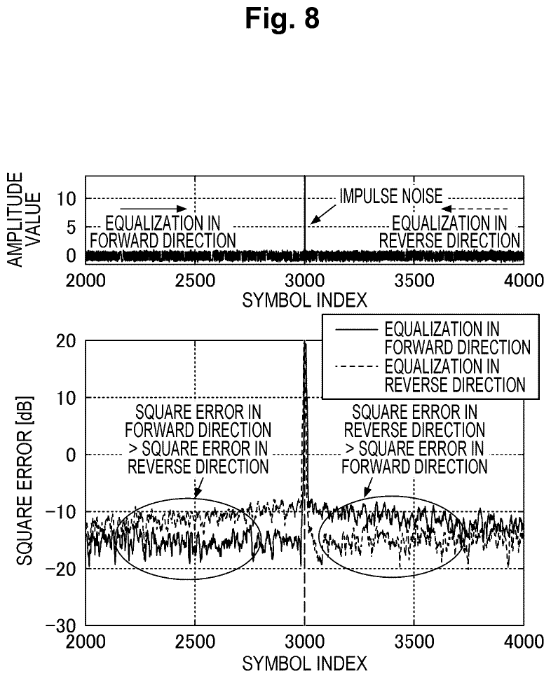

Next, a simulation result of the present embodiment is illustrated in FIG. 8. FIG. 8 is a diagram illustrating a simulation result of the present embodiment.

As illustrated in FIG. 8, the result of the waveform equalization (forward equalization) of the forward adaptive equalization unit 50a has a large square error after the impulse noise, and the result of the waveform equalization (backward equalization) of the backward adaptive equalization unit 50b has a large square error before the impulse noise.

From the above simulation results, it is possible to suppress deterioration in demodulation performance after occurrence of the impulse noise, by using the communication device 10 including means for sequentially selecting one of the equalizer output in the reverse direction and the equalizer output in the forward direction, or sequentially synthesizing both of them.

### First Embodiment

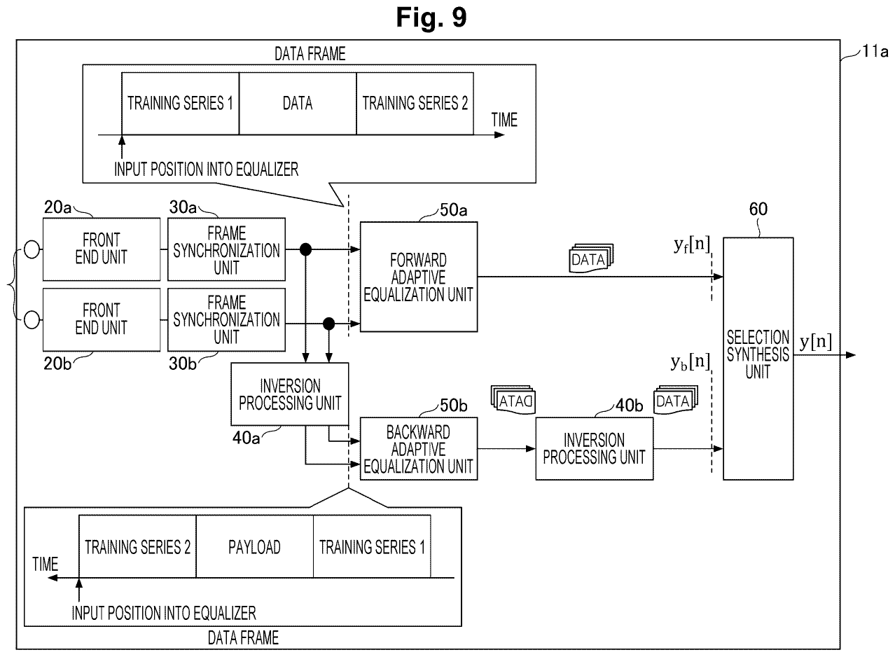

Next, a first embodiment will be described with reference to FIGS. 9 to 11.

### <Configuration of Communication Device>

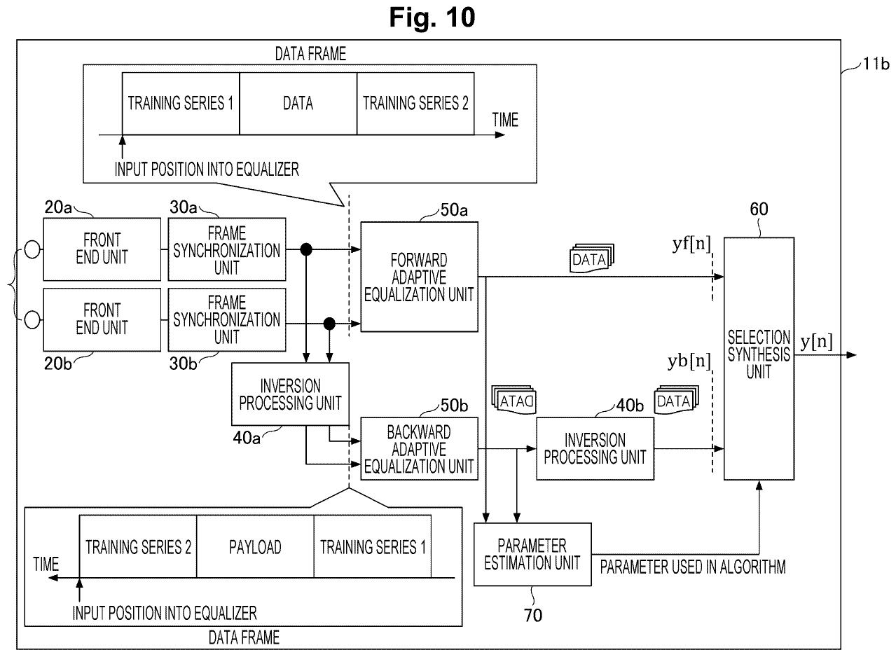

First, configurations of a communication device 11a according to the first embodiment and a communication device 11b as a modification will be described with reference to FIGS. 9 and 10. FIG. 9 is a configuration diagram of a communication device according to the first embodiment. FIG. 10 is a configuration diagram of a modification of the communication device according to the first embodiment. Note that the communication devices 11a and 11b are examples of the communication device 10.

As illustrated in FIG. 9, the communication device 11a includes front end units 20a and 20b, frame synchronization units 30a and 30b, inversion processing units 40a and 40b, a forward adaptive equalization unit 50a, a backward adaptive equalization unit 50b, and a selection synthesis unit 60. The communication device 11b further includes a parameter estimation unit 70 as compared with the communication device Ila. In a case where the communication device 11a fixes the parameter, the communication device 11b sequentially changes the parameter by estimating the parameter.

Note that configurations similar to those of the above-described premise technique are denoted by the same reference numerals, and description thereof will be omitted. Moreover, as described above, although the front end unit 20a and the frame synchronization unit 30a, and the front end unit 20b and the frame synchronization unit 30b are illustrated as a plurality of channels, three or more front end units and three or more frame synchronization units may be provided. Moreover, the generic name of the front end units 20a and 20b is referred to as a “front end unit 20”, and the generic name of the frame synchronization units 30a and 30b is referred to as a “frame synchronization unit 30”. Furthermore, the generic name of the inversion processing units 40a and 40b is referred to as an “inversion processing unit 40”. The internal configurations (refer to FIG. 2) of the forward adaptive equalization unit 50a and the backward adaptive equalization unit 50b are basically similar to those of the adaptive equalization unit 50.

The inversion processing unit 40 receives the received data of one frame as input, inverts the chronological order of the received data, and outputs the inverted data. For example, the inversion processing unit 40 outputs data of [#5, #4, #3, #2, #1] when data arranged in a chronological order such as [#1, #2, #3, #4, #5] is inputted. After passing through the inversion processing unit 40 twice, the data returns to the original chronological order.

The data frame has a configuration in which the training series are connected on both sides with the data portion sandwiched therebetween. The forward adaptive equalization unit 50a performs waveform equalization processing on a data frame sequentially inputted from the head position of the training series 1, and outputs data of an equalizer output. The backward adaptive equalization unit 50b sequentially inputs data from the head (in other words, the end of the data frame) of the training series 2 of the data frame whose chronological order has been inverted, performs waveform equalization processing on the data frame whose chronological order has been inverted, and outputs data of an equalizer output whose chronological order has been inverted. In this case, the inversion processing unit 40b inverts the chronological order of the data of the equalizer output outputted from the backward adaptive equalization unit 50b, and outputs the data of the equalizer output in a chronological order.

The selection synthesis unit 60 selects and outputs one of the data of the equalizer output of the forward adaptive equalization unit 50a and the data of the equalizer output of the inversion processing unit 40b after the processing of the backward adaptive equalization unit 50b, or synthesizes and outputs both of them.

The parameter estimation unit 70 estimates a set θ of parameters to be described later on the basis of the data of the equalizer output from the forward adaptive equalization unit 50a and the data of the equalizer output obtained by inverting the chronological order from the backward adaptive equalization unit 50b. Note that the set θ of parameters indicates one or more parameters (may indicate one parameter in some cases).

Here, the selection synthesis processing will be described in more detail.

Hereinafter, the equalizer output value of the n-th symbol (n=1 is the head symbol when the data units are arranged in a chronological order) of the forward adaptive equalization unit 50a is referred to as yf [n], and the equalizer output value of the n-th symbol of the backward adaptive equalization unit 50b is referred to as yb [n]. Similarly, in the configuration in FIG. 2, reference signal values for which the symbol determination unit 54 performs symbol determination on yf [n] and yb [n] are denoted as df [n] and db [b], respectively. Moreover, the output of the selection synthesis unit 60 is denoted as y [n]. Note that selection synthesis processing of three patterns will be described below.

### (First Selection Synthesis Processing)

The selection synthesis unit 60 performs symbol selection. The selection synthesis unit 60 compares the square value ef [n] of the error of the reference signal value df [n] and the equalizer output value yf [n] obtained by the error calculation unit 55 with the square value eb [n] of the error of the reference signal value db [n] and the equalizer output value yb [n] obtained by the error calculation unit 55, and selects an equalizer output having a smaller square error. That is, y [n] is determined on the basis of the following norm (Equation 1).

$$[ Math . 1 ]$$

$$y [ n ] = \{ \begin{matrix}{y}_{f} [ n ] , & if {e}_{f} [ n ] \leq {e}_{b} [ n ] \\ {y}_{b} [ n ] , & if {e}_{f} [ n ] > {e}_{b} [ n ]\end{matrix} \qquad ( Equation 1 )$$

The square error value may be, for example, a mean square error as a moving average.

### (Second Selection Synthesis Processing)

The parameter estimation unit 70 estimates a set 8G of parameters to be described later on the basis of the maximum likelihood estimation. The first selection synthesis processing is characterized in that a more accurate value can be obtained because the information to be used for selection increases although the calculation amount increases, as compared with the first selection synthesis processing. The selection norm follows (Equation 2) below.

$$[ Math . 2 ]$$

$$y [ n ] = \begin{matrix}argmax \\ s ∈ Σ\end{matrix} log ( f ( {y}_{f} [ n ] , {y}_{b} [ n ] \vert θ , s ) ) \qquad ( Equation 2 )$$

Here, Σ is a set of candidate points of the constellation. A function f( ) is a joint probability density function of yf [n] and yb [n] with a parameter set θ (θ is a set including a variable for determining the shape of one or more functions) for determining the shape of the function f and a constellation symbol s (s is also a parameter for determining the shape of the function f similarly to θ) by constellation mapping as a distribution parameter. Argmax means s taking the maximum value. In other words, this selection norm selects s that maximizes the function f.

As an example, in a case where yf [n] and yb [n] are regarded as independent random variables and the function f( ) is assumed to be a normal distribution, s corresponds to an average value and corresponds to θ={σ_{f}, σ_{b}}. That is, the function f is a joint probability density function of yf [n] and yb [n], and is specifically expressed in (Equation 3).

$$[ Math . 3 ]$$

$$f ( {y}_{f} [ n ] , {y}_{b} [ n ] \vert θ , s ) = f ( {y}_{f} [ n ] , {y}_{b} [ n ] \vert {σ}_{f} , {σ}_{b} , s ) = \frac{1}{2 {πσ}_{f} {σ}_{b}} exp ( - \frac{{( {y}_{f} [ n ] - s )}^{2}}{2 {σ}_{f}^{2}} - \frac{{( {y}_{b} [ n ] - s )}^{2}}{2 {σ}_{b}^{2}} ) \qquad ( Equation 3 )$$

In the case of normal distribution, the parameter set θ is expressed as θ={σ_{f}, σ_{b}}. On the other hand, s is an expected value in the normal distribution. Maximizing the above equation is obviously the same as minimizing the calculation formula expressed in (Equation 4).

$$[ Math . 4 ]$$

$$y [ n ] = \begin{matrix}argmax \\ s ∈ Σ\end{matrix} \frac{1}{{σ}_{f}^{2}} {\vert {y}_{f} [ n ] - s \vert}^{2} + \frac{1}{{σ}_{b}^{2}} {\vert {y}_{b} [ n ] - s \vert}^{2} \qquad ( Equation 4 )$$

Here, σ_{f} is a variance value of yf [n], and the parameter estimation unit 70 estimates the parameter σ_{f} by performing calculation using (Equation 5) on the basis of, for example, the reference signal value df [n] and the sample average of the square error value ef [n] of the equalizer output yf [n].

$$[ Math . 5 ]$$

$${σ}_{f}^{2} = \frac{1}{N} {\sum }_{n = 1}^{N} {e}_{f} [ n ] \qquad ( Equation 5 )$$

Similarly, σ_{b} is a variance value of yb [n], and the parameter estimation unit 70 estimates the parameter σ_{b} by performing calculation using (Equation 6) on the basis of the reference signal value db [n] and the square error value eb [n] of the equalizer output yb [n].

$$[ Math . 6 ]$$

$${σ}_{b}^{2} = \frac{1}{N} {\sum }_{n = 1}^{N} {e}_{b} [ n ] \qquad ( Equation 6 )$$

The function f( ) that gives the probability density function is not limited to the normal distribution, and any distribution type may be used. Accordingly, the set θ of parameters also differs according to the assumed function f( ), and the estimation equation of the set θ of parameters is also determined according to the function f( ).

As in the above example, the estimation processing of the parameter set θ may be a universal estimator including an average or the like, or may be a maximum likelihood estimator or an effective estimator. The efficiency with respect to the Cramer-Rao lower bound may be an estimator of less than 100%. Alternatively, a value recorded in advance by the system may be used as the set θ of parameters.

### (Third Selection Synthesis Processing)

The selection synthesis unit 60 performs synthesis processing of yf [n] and yb [n]. The calculation formula (Equation 7) used for synthesis is as follows.

$$[ Math . 7 ]$$

$$y [ n ] = {y}_{f} [ n ] {k}_{1} + {y}_{b} [ n ] {k}_{2} \qquad ( Equation 7 )$$

Here, k1 and k2, which are weightings, are constants determined on the basis of the loss function. For example, the loss function is defined by a reciprocal of the square value ef [n] of the error and the square value eb [n] of the error described above, and may be calculated and determined by the parameter estimation unit 70 using the following Equation.

$$[ Math . 8 ]$$

$$k 1 = \frac{1}{ef [ n ]} , k 2 = \frac{1}{{e}_{b} [ n ]}$$

In other words, the present example is a norm for synthesis by applying larger weight to a smaller square error and reducing the smaller weight of the square error.

### <Processing or Operation in First Embodiment>

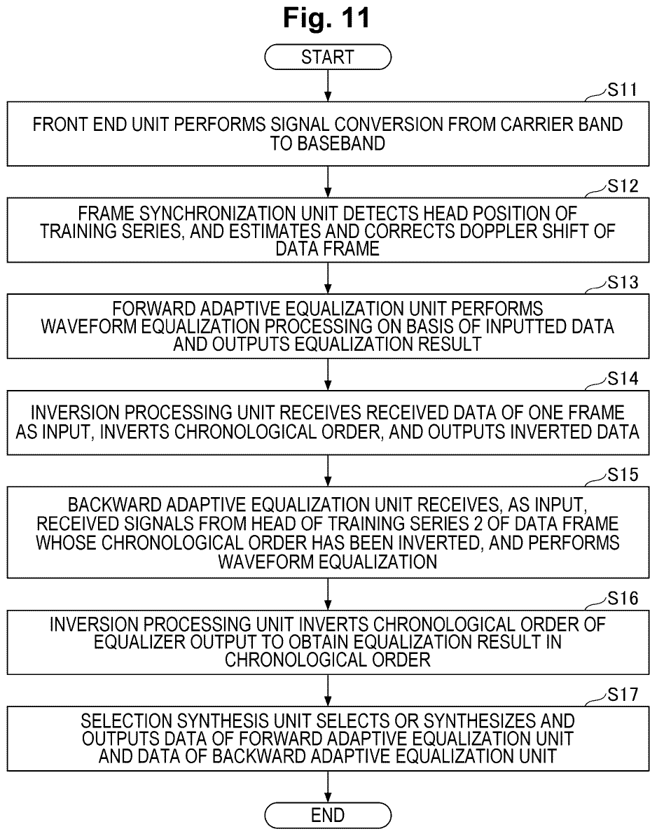

Next, basic processing or operation of the first embodiment will be described with reference to FIG. 11. FIG. 11 is a flowchart illustrating a communication method executed by the communication device according to the first embodiment.

S11: The front end unit 20 performs signal conversion from the carrier band to the baseband.

S12: The frame synchronization unit 30 detects the head position of the training series, and estimates and corrects the Doppler shift of the data frame.

S13: The forward adaptive equalization unit 50a performs waveform equalization processing on the basis of inputted data, and outputs data of an equalizer output (equalization result).

S14: The inversion processing unit 40a receives received data of one frame as input, inverts the chronological order of the received data, and outputs the inverted data.

S15: The backward adaptive equalization unit 50b sequentially receives, as input, received signals from the head of the training series 2 of the data frame whose chronological order has been inverted, and performs waveform equalization.

S16: The inversion processing unit 40b inverts the chronological order of the equalizer output to obtain an equalizer output (equalization result) in a chronological order.

S17: The selection synthesis unit sequentially selects and outputs one of data of the forward adaptive equalization unit and data of the backward adaptive equalization unit, or sequentially synthesizes and outputs both of them.

Note that the parameter estimation unit 70 estimates the set θ of parameters on the basis of data of the equalizer output from the forward adaptive equalization unit 50a and data of the equalizer output obtained by inverting the chronological order from the backward adaptive equalization unit 50b.

### <Main Advantageous Effects of First Embodiment>

As described above, according to the first embodiment, the communication devices 11a and 11b perform equalization from a direction going back with respect to the time axis and perform selection and synthesis by using the property that temporary deterioration in the equalization characteristic starting from the impulse noise extends backward with respect to the equalization direction. As a result, an effect is provided that it is possible to suppress deterioration in performance of the adaptive equalization unit even in an underwater environment accompanied by impulse noise.

### Second Embodiment

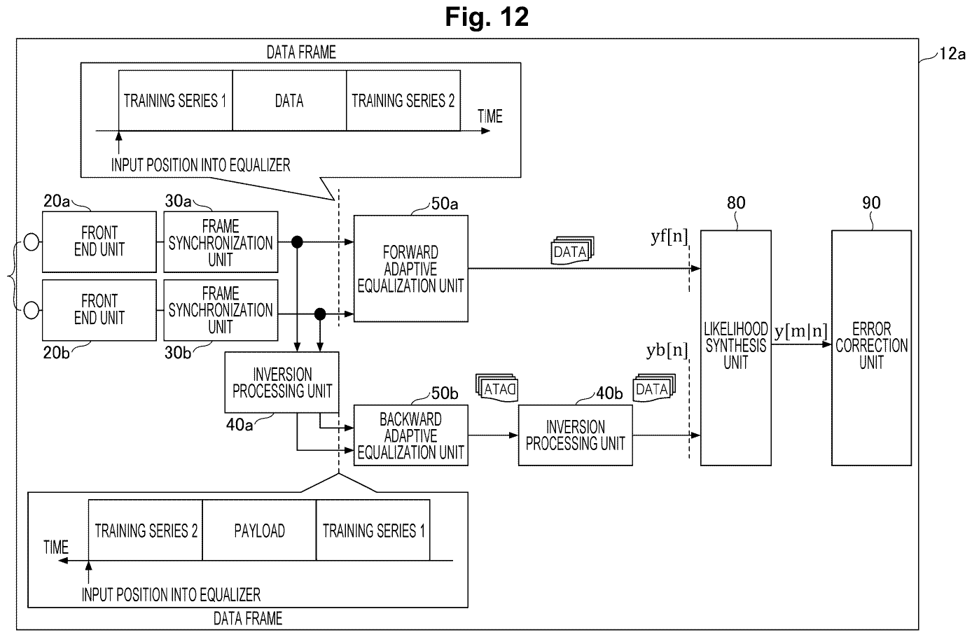

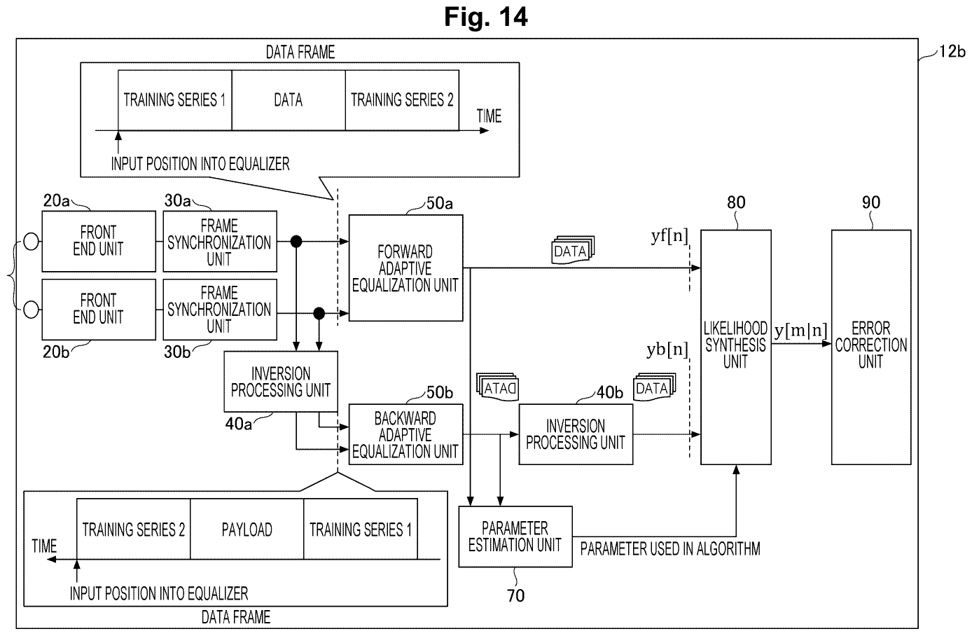

Next, a second embodiment will be described with reference to FIGS. 12 to 15.

### <Configuration of Communication Device>

First, a configuration of a communication device 12a according to the second embodiment will be described with reference to FIG. 12. FIG. 12 is a configuration diagram of a communication device according to the second embodiment. Note that the communication device 12a is an example of the communication device 10.

As illustrated in FIG. 12, the communication device 12a includes front end units 20a and 20b, frame synchronization units 30a and 30b, inversion processing units 40a and 40b, a forward adaptive equalization unit 50a, a backward adaptive equalization unit 50b, a likelihood synthesis unit 80, and an error correction unit 90. A communication device 12b further includes a parameter estimation unit 70 as compared with the communication device 12a. The communication device 12a is a case of fixing the parameter, while the communication device 12b is a case of sequentially changing the parameter by estimating the parameter. Note that configurations and generic names similar to those in the above-described first embodiment are denoted by the same reference numerals, and description thereof will be omitted.

Note that the second embodiment is different from the first embodiment in that the likelihood of the bit level is calculated from the calculation results of the forward adaptive equalization unit 50a and the backward adaptive equalization unit 50b, and error correction processing is performed.

The likelihood synthesis unit 80 generates a likelihood, a likelihood ratio, or a log likelihood ratio of the bit level from the calculation results of the forward adaptive equalization unit 50a and the backward adaptive equalization unit 50b. The error correction unit 90 performs error correction on the basis of the likelihood, the likelihood ratio, or the log likelihood ratio generated by the likelihood synthesis unit 80. Note that the error correction unit 90 can perform error correction on the basis of any of the likelihood, the likelihood ratio, and the log likelihood ratio because the likelihood, the likelihood ratio, and the log likelihood ratio are equivalent contents as information. Here, the likelihood synthesis unit 80 will be described in more detail.

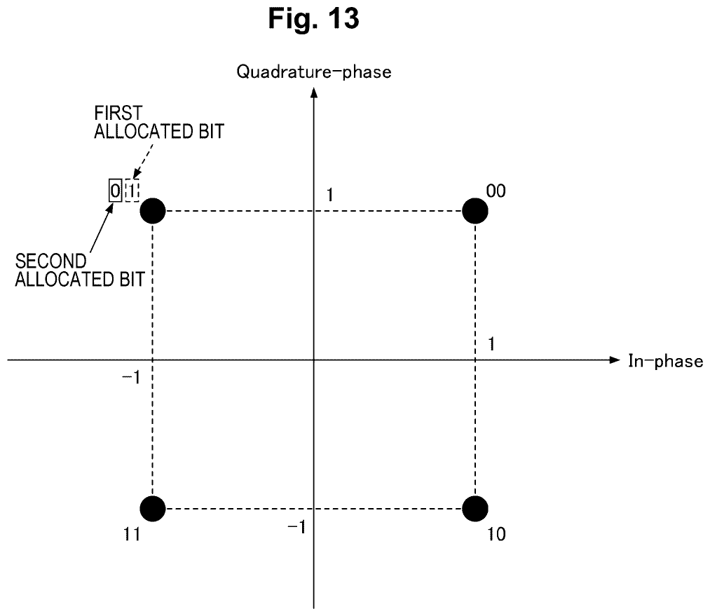

The y [m|n] is a likelihood for the m-th allocated bit in the n-th symbol. For example, in quadrature phase shift keying (QPSK) modulation, two bits can be allocated for one symbol, so that the correspondence illustrated in FIG. 13 is obtained. FIG. 13 is a diagram illustrating QPSK mapping and a bit correspondence example. Note that two patterns of the likelihood synthesis unit 80 will be described.

### (First Likelihood Synthesis Processing)

Assuming that the error correction is performed on the output of the likelihood synthesis unit 80, the likelihood synthesis unit 80 calculates the “log likelihood ratio” of the bit level of each symbol using the following (Equation 8) and outputs the log likelihood ratio.

$$[ Math . 9 ]$$

$$y [ m \vert n ] = log ( \frac{{\sum }_{s ∈ {Σ}_{0 , m}} f ( {y}_{f} [ n ] , {y}_{b} [ n ] \vert θ , s )}{{\sum }_{s ∈ {Σ}_{1 , m}} f ( {y}_{f} [ n ] , {y}_{b} [ n ] \vert θ , s )} ) \qquad ( Equation 8 )$$

Here, log( ) indicates the “likelihood ratio”. Furthermore, the numerator in log( ) is the “likelihood” when the m-th bit allocation of the bit is 0. That is, Σ_{0,m} is a set of constellation mappings in which the m-th bit allocation is 0. On the other hand, the denominator in log( ) is the “likelihood” when the m-th bit allocation of the bit is 1. That is, Σ_{0,m} is a set of constellation mappings in which the m-th bit allocation is 1. For example, the following table is obtained by taking FIG. 13 as an example. The function f( ) is a joint probability density function listed in the selection synthesis unit 60 illustrated in FIG. 10 of the first embodiment. Each parameter in the function f( ) is the same as the content described on the selection synthesis unit 60 illustrated in FIG. 10 of the first embodiment.

TABLE 2

| First allocated bit | Point |
|---|---|
| Σ_{1, 1} | 1 − 1i and −1 − 1i |
| Σ_{0, 1} | 1 + 1i and 1 − 1i |

TABLE 3

| Second allocated bit | Point |
|---|---|
| Σ_{2, 1} | −1 − 1i and −1 + 1i |
| Σ_{2, 0} | 1 − 1i and 1 + 1i |

As an example, assuming that yf [n] and yb [n] are independent random variables and the function f( ) is a normal distribution, s corresponds to an average value, and a set θ of parameters corresponds to variance values or and σ_{b}. The shape of f( ) at this time is expressed by the above (Equation 3). By substituting (Equation 3) into (Equation 8) of the log likelihood, a specific calculation formula (Equation 9) is obtained.

$$[ Math . 10 ]$$

$$y [ m \vert n ] = log ( \frac{{\sum }_{{s}_{0} ∈ {Σ}_{0 , m}} ( - \frac{{\vert {y}_{f} [ n ] - {s}_{0} \vert}^{2}}{2 {σ}_{f}^{2}} - \frac{{\vert {y}_{b} [ n ] - {s}_{0} \vert}^{2}}{2 {σ}_{b}^{2}} )}{{\sum }_{{s}_{0} ∈ {Σ}_{1 , m}} ( - \frac{{\vert {y}_{f} [ n ] - {s}_{1} \vert}^{2}}{2 {σ}_{f}^{2}} - \frac{{\vert {y}_{b} [ n ] - {s}_{1} \vert}^{2}}{2 {σ}_{b}^{2}} )} ) \qquad ( Equation 9 )$$

Here, the variance values σ_{f} and σ_{b} are estimated by, for example, (Equation 5) and (Equation 6).

Note that the above is an example, the type f( ) of the distribution that gives the probability density function is not limited to the normal distribution, and any distribution type may be used. The estimation of the set θ of parameters may be a universal estimator including an average or the like, or may be a maximum likelihood estimator or an effective estimator. The efficiency with respect to the Cramer-Rao lower bound may be an estimator of less than 100%. Alternatively, a value recorded in advance by the system may be used as the set of parameters.

### (Second Likelihood Synthesis Processing)

The second likelihood synthesis processing is an approximate method of the first likelihood synthesis processing, and is advantageous in that the calculation amount can be reduced as compared with the first likelihood synthesis processing. Specifically, the likelihood synthesis unit 80 of the communication device 12b takes the maximum value of each numerator and denominator as illustrated by the joint probability density function in (Equation 10).

$$[ Math . 11 ]$$

$$y [ m \vert n ] = log ( \frac{{max}_{s ∈ {Σ}_{0 , m}} f ( {y}_{f} [ n ] , {y}_{b} [ n ] \vert θ , s )}{{max}_{s ∈ {Σ}_{1 , m}} f ( {y}_{f} [ n ] , {y}_{b} [ n ] \vert θ , s )} ) \qquad ( Equation 10 )$$

That is, the calculation amount is reduced by selecting the function value of the predetermined constellation symbol having the maximum function value, and the likelihood, the likelihood ratio, or the log likelihood ratio is calculated. Note that f(y_{f} [n], y_{b} [n]|θ, s) is a “likelihood function”, and θ represents a “set of parameters”.

As an example, assuming that yf [n] and yb [n] are independent random variables and the likelihood function f( ) is a normal distribution, s corresponds to an average value, and θ corresponds to variance values σ_{f} and σ_{b}. A specific calculation formula at this time is given as an approximate calculation formula (Equation 11) for the first likelihood synthesis processing as follows.

$$[ Math . 12 ]$$

$$y [ m \vert n ] = {min}_{{s}_{0} ∈ {Σ}_{0 , m}} ( \frac{{\vert {y}_{f} [ n ] - {s}_{0} \vert}^{2}}{2 {σ}_{f}^{2}} + \frac{{\vert {y}_{b} [ n ] - {s}_{0} \vert}^{2}}{2 {σ}_{b}^{2}} ) - {min}_{{s}_{0} ∈ {Σ}_{1 , m}} ( \frac{{\vert {y}_{f} [ n ] - {s}_{1} \vert}^{2}}{2 {σ}_{f}^{2}} + \frac{{\vert {y}_{b} [ n ] - {s}_{1} \vert}^{2}}{2 {σ}_{b}^{2}} ) \qquad ( Equation 11 )$$

In this case, the likelihood synthesis unit 80 selects a candidate point having the smallest value, instead of adding all of the set of candidate points.

Moreover, the parameter estimation unit 70 estimates the parameter σ_{f} and the parameter σ_{f} on the basis of data of the first equalizer output outputted by the forward adaptive equalization unit 50a and data of the second equalizer output outputted by the backward adaptive equalization unit 50b.

As described above, it can be seen that the log calculation and the calculation of the exponentiation of the Napier constant can be omitted in the second likelihood synthesis processing as compared with the first likelihood synthesis processing.

Note that the shape of distribution f( ) that gives the probability density function is not limited to the normal distribution, and any distribution type may be used. The population parameter estimation means may be a universal estimator including an average or the like, a maximum likelihood estimator, or an effective estimator. Alternatively, a value recorded in advance by the system may be used as the population parameter.

### <Processing of Second Embodiment>

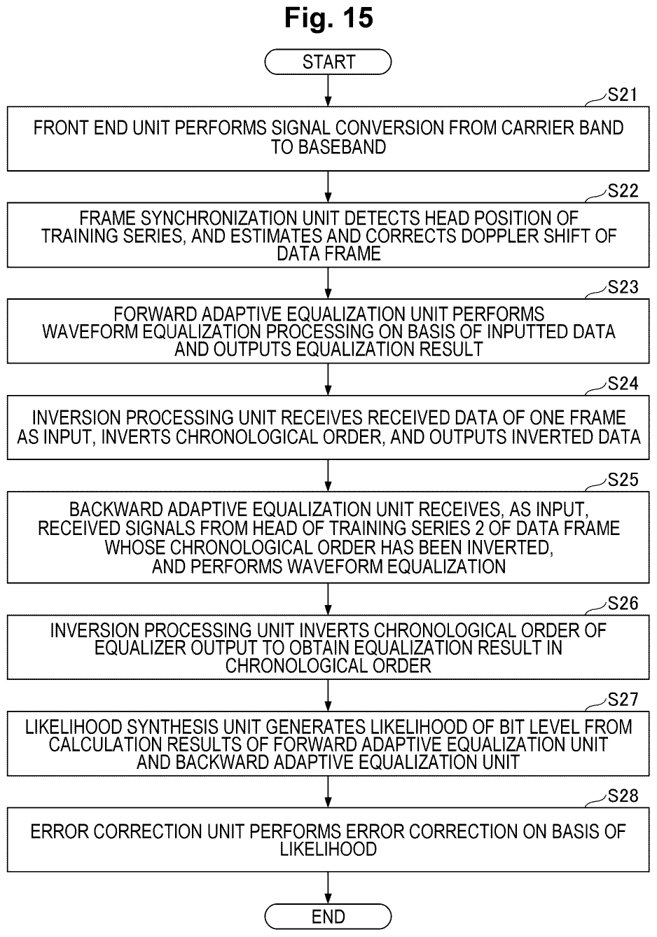

Next, basic processing or operation of the second embodiment will be described with reference to FIG. 15. FIG. 15 is a flowchart illustrating a communication method executed by the communication device according to the second embodiment. Note that, since processing S21 to S26 illustrated in FIG. 15 has contents similar to those of the processing S11 to S16 illustrated in FIG. 11, the description thereof will be omitted, and processing from S27 will be described.

S27: The likelihood synthesis unit 80 generates a likelihood or the like of the bit level from the calculation results of the forward adaptive equalization unit 50a and the backward adaptive equalization unit 50b.

S28: The error correction unit performs error correction on the basis of the likelihood.

Note that, also in the second embodiment, the parameter estimation unit 70 may perform estimation processing similarly to the first embodiment.

### <Main Advantageous Effects of Second Embodiment>

As described above, according to the second embodiment, an effect is provided that the communication devices 12a and 12b can improve the demodulation performance more than the first embodiment by the error correction based on the likelihood.

### [Supplementary Notes]

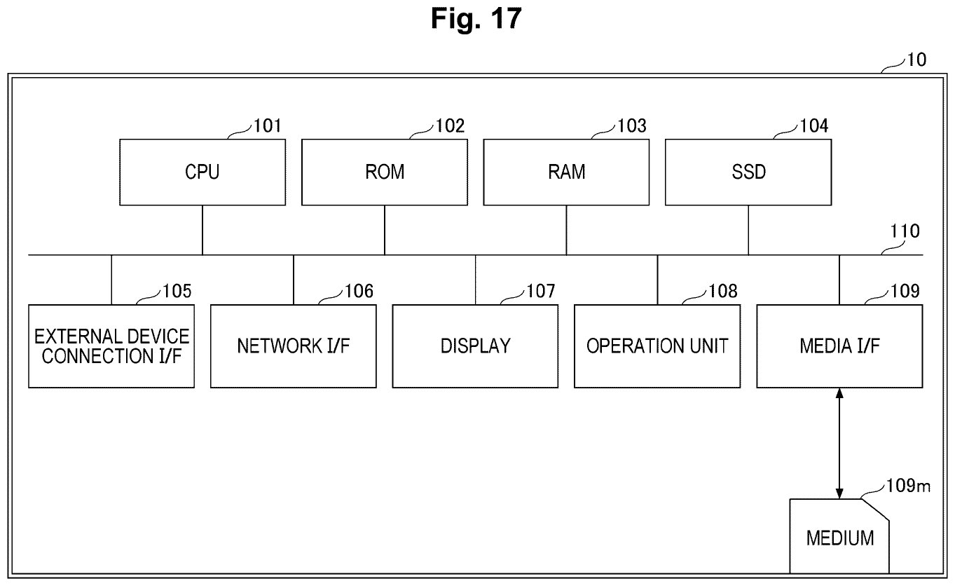

(1) Each of the configurations illustrated in FIGS. 2, 9, 10, 12, and 14 may include a device such as a circuit module, and a part or all of each of the above configurations may be a function or means realized by being operated by a command from the CPU 301 according to a program developed on the RAM 103 from the SSD 104 of the communication device 10 as a computer illustrated in FIG. 17. FIG. 17 is a hardware configuration diagram of a communication device as a computer.

As illustrated in FIG. 17, the communication device 10 includes, as a computer, a CPU 101, a ROM 102, a RAM 103, an SSD 104, an external device connection interface (I/F) 105, a network I/F 106, a display 107, an operation unit 108, a media I/F 109, and a bus line 110.

Among them, the CPU 101 controls the operation of the entire communication device 10. The ROM 102 stores a program used for driving the CPU 101, such as an IPL. The RAM 103 is used as a work area of the CPU 101.

The SSD 104 reads or writes various kinds of data under the control of the CPU 101. Note that the SSD 104 may not be provided in a case where the communication device 10 is a smartphone or the like. Moreover, a hard disk drive (HDD) may be provided instead of the SSD 104.

The external device connection I/F 105 is an interface for connecting various external devices. Examples of the external devices in this case include a display, a speaker, a keyboard, a mouse, a USB memory, and a printer.

The network I/F 106 is an interface for data communication via a communication network such as the Internet.

The display 107 is a type of display means such as liquid crystal or organic electro luminescence (EL) that displays various images.

The operation unit 108 is input means for selecting and executing various instructions, selecting a processing target, and moving a cursor, such as various operation buttons, a power switch, a shutter button, or a touch panel.

The media I/F 109 controls reading or writing (storing) of data from or in a recording medium 109m such as a flash memory. Examples of the recording medium 109m also include a DVD, a Blu-ray Disc (registered trademark), and the like.

The bus line 110 is an address bus, a data bus, or the like for electrically connecting the components such as the CPU 101 illustrated in FIG. 17.

(2) The program of the communication device 10 can be recorded in a (non-transitory) recording medium and provided, or can be provided via a communication network such as the Internet.

(3) The CPU 101 as a processor may be not only a single CPU but also a plurality of CPUs.

### REFERENCE SIGNS LIST

9 Receiver array
10 Communication device
20a, 20b Front end unit
30a, 30b Frame synchronization unit
40a, 40b Inversion processing unit
50a Forward adaptive equalization unit
50b Backward adaptive equalization unit
51a, 51b Carrier phase compensation unit
52a, 52b Feedforward filter unit
53 Feedback filter unit
54 Symbol determination unit
55 Error calculation unit
56 Adaptive algorithm unit
57 DPLL algorithm unit
60 Selection synthesis unit
70 Parameter estimation unit
80 Likelihood synthesis unit
90 Error correction unit
100 Communication device

1. A communication apparatus for performing acoustic communication underwater, the communication apparatus comprising:
a forward adaptive equalization circuit configured to perform waveform equalization on a data frame acquired by the acoustic communication in chronological order;
a backward adaptive equalization circuit configured to perform waveform equalization on the data frame in reverse chronological order; and
a selection synthesis circuit configured to:
sequentially select and output one of first data of a first equalizer output from the forward adaptive equalization circuit and second data of a second equalizer output from the backward adaptive equalization circuit, or
sequentially synthesize and output both of the first data and the second data.

2. The communication apparatus according to claim 1, wherein the selection synthesis circuit is configured to:
compare a first error between a reference signal that is a training series in the data frame and the first data with a second error between the reference signal and the second data, and
output the data having a smaller error among the first data and the second data.

3. The communication apparatus according to claim 1, wherein the selection synthesis circuit is configured to:
calculate a likelihood based on a joint probability density function of the first data and the second data, and
select a predetermined constellation symbol having a highest likelihood in a case where the constellation symbol is used as a parameter of a first distribution.

4. The communication apparatus according to claim 3, wherein the selection synthesis circuit is configured to synthesize the first data and the second data based on weighting by a loss function.

5. The communication apparatus according to claim 4, further comprising:
a parameter estimation circuit configured to estimate one or more parameters of a second distribution that defines a distribution type of the loss function, based on the first data and the second data.

6. A communication apparatus for performing acoustic communication underwater, the communication apparatus comprising:
a forward adaptive equalization circuit configured to perform waveform equalization on a data frame acquired by the acoustic communication in chronological order;
a backward adaptive equalization circuit configured to perform waveform equalization on the data frame in reverse chronological order;
a likelihood synthesis circuit configured to calculate a likelihood, a likelihood ratio, or a log likelihood ratio, based on both first data of a first equalizer output from the forward adaptive equalization circuit and second data of a second equalizer output from the backward adaptive equalization circuit; and
an error correction circuit configured to perform error correction of a data portion in the data frame based on the likelihood, the likelihood ratio, or the log likelihood ratio.

7. The communication apparatus according to claim 6, wherein the likelihood synthesis circuit is configured to calculate the likelihood, the likelihood ratio, or the log likelihood ratio based on a joint probability density function of the first data and the second data.

8. The communication apparatus according to claim 7, wherein the likelihood synthesis circuit is configured to calculate the likelihood, the likelihood ratio, or the log likelihood ratio by selecting a predetermined constellation symbol having a maximum function value based on a joint probability density function of the first data and the second data in a case where the constellation symbol is used as a parameter of a first distribution.

9. The communication apparatus according to claim 8, further comprising:
a parameter estimation circuit configured to estimate one or more parameters of a second distribution that defines a distribution type of a likelihood function, based on the first data and the second data.

10. A communication method executed by a communication apparatus that performs acoustic communication underwater, comprising:
performing first waveform equalization on a data frame acquired by the acoustic communication in chronological order;
performing second waveform equalization on the data frame in reverse chronological order; and
sequentially selecting and outputting one of first data of a first equalizer output by the first waveform equalization and second data of a second equalizer output by the second waveform equalization, or sequentially synthesizing and outputting both of the first data and the second data.
